(19) United States
(12) Patent Application Publication
(10) Pub. No.: US 2018/0213907 A1
(43) Pub. Date: Aug. 2, 2018

(54) Personal Luggage Identifying Device

(71) Applicant: Willie Haggan, Jersey city, NJ (US)

(72) Inventor: Willie Haggan, Jersey city, NJ (US)

(21) Appl. No.: 15/417,840

(22) Filed: Jan. 27, 2017

(51) Int. Cl. A45C 13/42; G09F 13/00; G09F 13/22; G08B 5/36

(52) U.S. Cl. CPC A45C 13/42; G09F 13/005; G09F 2013/222; G08B 5/36; G09F 13/22

(57) ABSTRACT

A personal luggage identifying device for pinpointing a suitcase includes a strap that is configured to couple to the suitcase. A first housing is coupled to the strap. The first housing defines an internal space. A first power module is coupled to the first housing and is positioned in the internal space. A plurality of lights is coupled to the strap. A controller is coupled to the first housing. The controller is operationally coupled to the first power module and the plurality of lights. The controller is positioned to selectively operationally couple the lights to the first power module. The lights are selectively illuminated to identify the suitcase.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to identifying devices and more particularly pertains to a new identifying device for pinpointing a suitcase.

### BRIEF SUMMARY OF THE INVENTION

An embodiment of the disclosure meets the needs presented above by generally comprising a strap that is configured to couple to the suitcase. A first housing is coupled to the strap. The first housing defines an internal space. A first power module is coupled to the first housing and is positioned in the internal space. A plurality of lights is coupled to the strap. A controller is coupled to the first housing. The controller is operationally coupled to the first power module and the plurality of lights. The controller is positioned to selectively operationally couple the lights to the first power module. The lights are selectively illuminated to identify the suitcase.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a personal luggage identifying device according to an embodiment of the disclosure.

FIG. 2 is a bottom view of an embodiment of the disclosure.

FIG. 3 is a cross-sectional view of an embodiment of the disclosure.

FIG. 4 is an isometric perspective view of an embodiment of the disclosure.

FIG. 5 is an in-use view of an embodiment of the disclosure.

FIG. 6 is an in-use view of an embodiment of the disclosure.

### DETAILED DESCRIPTION OF THE INVENTION

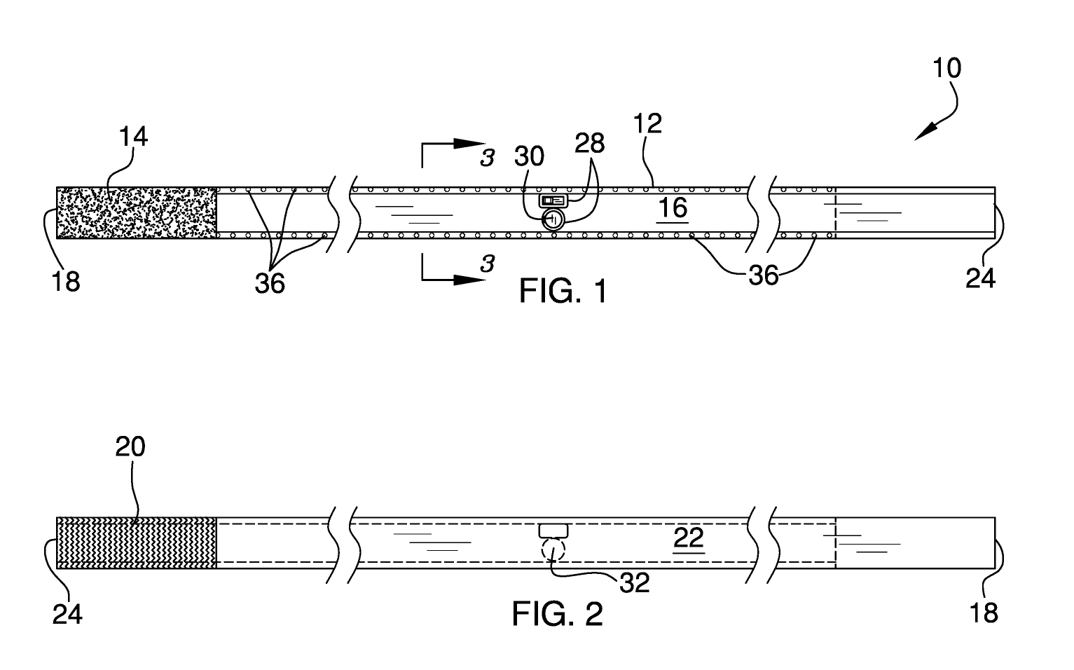

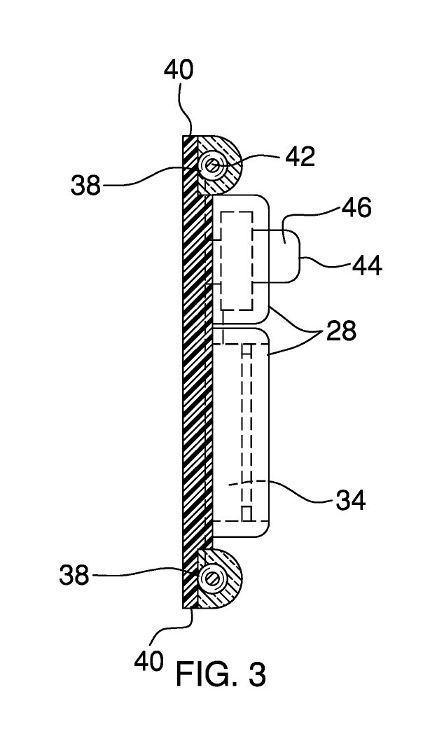

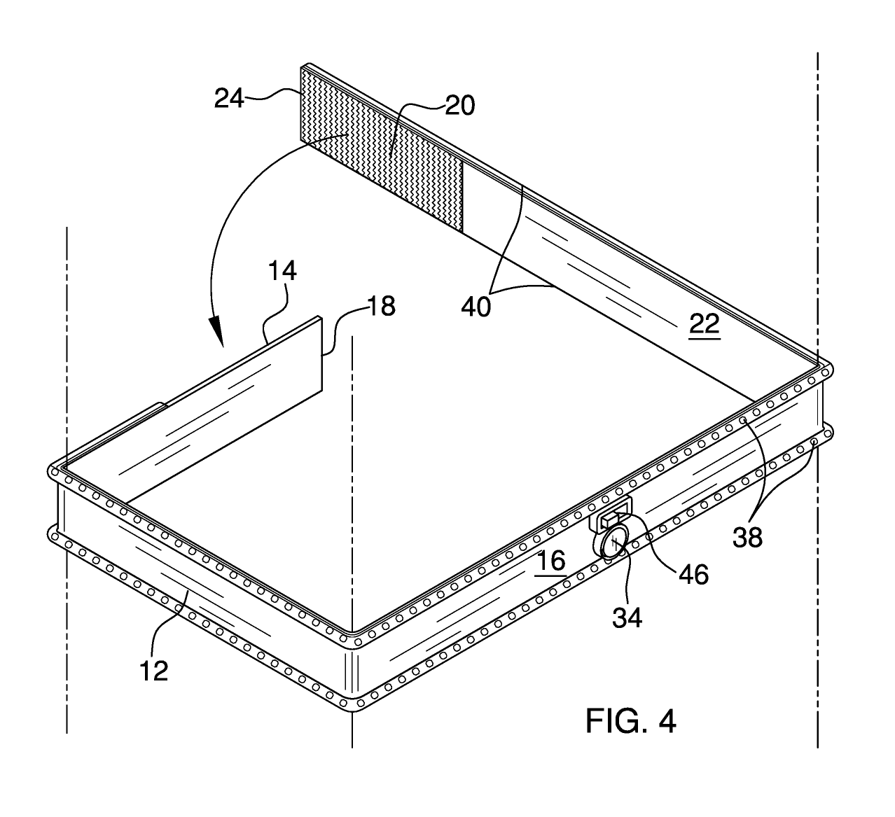

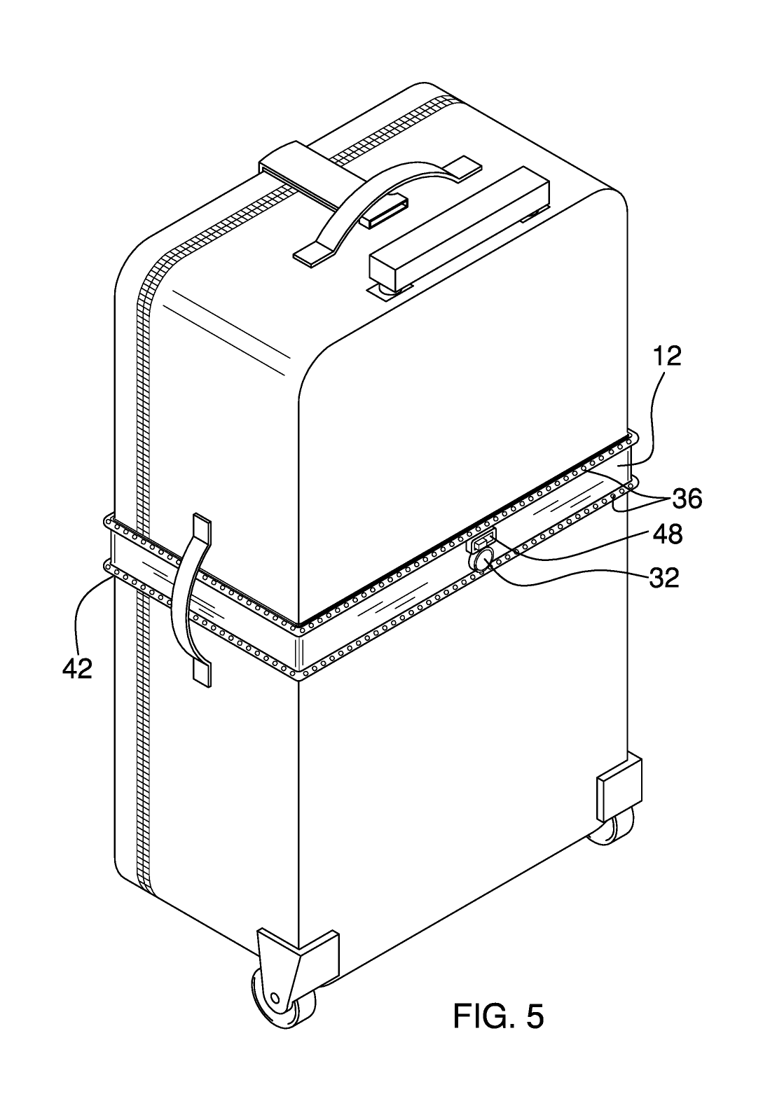

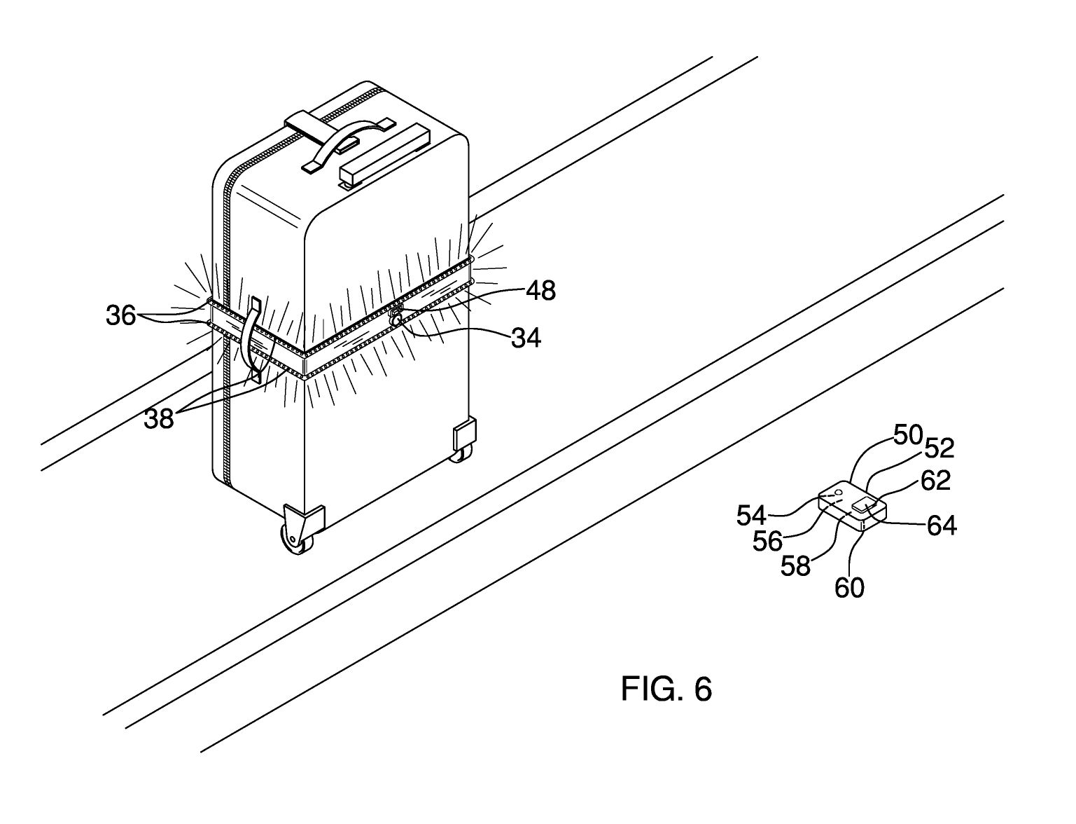

With reference now to the drawings, and in particular to FIGS. 1 through 6 thereof, a new identifying device embodying the principles and concepts of an embodiment of the disclosure and generally designated by the reference numeral 10 will be described.

As best illustrated in FIGS. 1 through 6, the personal luggage identifying device 10 generally comprises a strap 12 that is configured to couple to a suitcase. In one embodiment, a first fastener 14 is coupled to an upper face 16 of the strap 12 adjacent to a first end 18 of the strap 12. A second fastener 20 is coupled to a lower face 22 of the strap 12 adjacent to a second end 24 of the strap 12. The second fastener 20 is complementary to the first fastener 14. The second fastener 20 is positioned to couple to the first fastener 14 to couple the strap 12 to the suitcase. In another embodiment, the first fastener 14 and the second fastener 20 comprises a hook and loop fastener 26.

A first housing 28 is coupled to the strap 12. The first housing 28 defines an internal space 30. In one embodiment, the first housing 28 is positioned substantially equally distant from the first end 18 and the second end 24 of the strap 12.

A first power module 32 is coupled to the first housing 28 and is positioned in the internal space 30. In one embodiment, the first power module 32 comprises at least one first battery 34.

A plurality of lights 36 is coupled to the strap 12. In one embodiment, the plurality of lights 36 comprises a pair of strips 38. Each strip 38 is coupled to the strap 12 proximate to a respective opposing edge 40 of the strap 12. In one embodiment, each strip 38 extends between the first fastener 14 and the second fastener 20. In another embodiment, the lights 36 comprise light emitting diodes 42.

A controller 44 is coupled to the first housing 28. The controller 44 is operationally coupled to the first power module 32 and the plurality of lights 36. The controller 44 is positioned to selectively operationally couple the lights 36 to the first power module 32. The lights 36 are selectively illuminated to identify the suitcase. In one embodiment, the controller 44 comprises a switch 46. The switch 46 is slidable. The switch 46 is positioned to be slid to selectively operationally couple the lights 36 to the first power module 32. In another embodiment, the controller 44 comprises a receiver 48. The receiver 48 is configured to receive wireless signal.

A remote 50 is operationally coupled to the controller 44. The remote 50 is positioned to wirelessly signal the controller 44 to selectively couple the first power module 32 to the lights 36. The lights 36 are selectively illuminated to identify the suitcase.

In one embodiment, the remote 50 comprises a second housing 52 that defines an interior space 54. A second power module 56 is coupled to the second housing 52 and is positioned in the interior space 54. In another embodiment, the second power module 56 comprises at least one second battery 58.

A transmitter 60 is coupled to the second housing 52 and is positioned in the interior space 54. The transmitter 60 is operationally coupled to the second power module 56. The transmitter 60 is configured to send the wireless signal.

A control module 62 is coupled to the second housing 52. The control module 62 is operationally coupled to the transmitter 60. The control module 62 is positioned to compel the transmitter 60 to transmit the wireless signal. The receiver 48 is positioned to receive the wireless signal. The controller 44 is positioned to selectively compel the first power module 32 to couple to the lights 36. The lights 36 are selectively illuminated to identify the suitcase. In yet another embodiment, the control module 62 comprises a button 64. The button 64 is depressible. The button 64 is configured to be depressed to compel the transmitter 60 to transmit the wireless signal.

In use, the second fastener 20 is positioned to couple to the first fastener 14 to couple the strap 12 to the suitcase. The switch 46 is positioned to be slid to selectively operationally couple the lights 36 to the first power module 32. The lights 36 are selectively illuminated to identify the suitcase. The button 64 is configured to be depressed to compel the transmitter 60 to transmit the wireless signal. The receiver 48 is positioned to receive the wireless signal. The controller 44 is positioned to selectively compel the first power module 32 to couple to the lights 36. The lights 36 are selectively illuminated to identify the suitcase.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

1. A personal luggage identifying device comprising:
a strap configured for coupling to a suitcase;
a first housing coupled to said strap, said first housing defining an internal space;
a first power module coupled to said first housing and positioned in said internal space;
a plurality of lights coupled to said strap, each of said lights being positioned on said strap;
a controller coupled to said first housing, said controller being operationally coupled to said first power module and said plurality of lights; and
wherein said controller is positioned on said first housing such that said controller is positioned for selectively operationally coupling said lights to said first power module, such that said lights are selectively illuminated to identify the suitcase.

2. The device of claim 1, further comprising:
a first fastener coupled to an upper face of said strap adjacent to a first end of said strap;
a second fastener coupled to a lower face of said strap adjacent to a second end of said strap, said second fastener being complementary to said first fastener; and
wherein said second fastener is positioned on said strap such that said second fastener is positioned to couple to said first fastener to couple said strap to the suitcase.

3. The device of claim 2, further including said first fastener and said second fastener comprising a hook and loop fastener.

4. The device of claim 1, further including said first housing being positioned substantially equally distant from a first end and a second end of said strap.

5. The device of claim 1, further including said first power module comprising at least one first battery.

6. The device of claim 2, further including said lights comprising light emitting diodes.

7. The device of claim 5, further including said plurality of lights comprising a pair of strips, each said strip being coupled to said strap proximate to a respective opposing edge of said strap.

8. The device of claim 7, further including each said strip extending between said first fastener and said second fastener.

9. The device of claim 1, further including said controller comprising a switch, said switch being slidable, wherein said switch is positioned for sliding for selectively operationally coupling said lights to said first power module.

10. The device of claim 1, further comprising:
said controller comprising a receiver, said receiver being configured for receiving wireless signal;
a remote operationally coupled to said controller; and
wherein said remote is positioned for wirelessly signaling said controller to selectively couple said first power module to said lights, such that said lights are selectively illuminated to identify the suitcase.

11. The device of claim 10, further including said remote comprising:
a second housing defining an interior space;
a second power module coupled to said second housing and positioned in said interior space;
a transmitter coupled to said second housing and positioned in said interior space, said transmitter being operationally coupled to said second power module, said transmitter being configured for sending wireless signal;
a control module coupled to said second housing, said control module being operationally coupled to said transmitter; and
wherein said control module is positioned on said second housing such that said control module is positioned for compelling said transmitter to transmit the wireless signal, such that said receiver is positioned for receiving the wireless signal, wherein said controller is positioned for selectively compelling coupling of said first power module to said lights, such that said lights are selectively illuminated to identify the suitcase.

12. The device of claim 11, further including said second power module comprising at least one second battery.

13. The device of claim 11, further including said control module comprising a button, said button being depressible, wherein said button is positioned on said second housing such that said button is configured for depressing for compelling said transmitter to transmit the wireless signal.

14. A personal luggage identifying device comprising:
a strap configured for coupling to a suitcase;
a first fastener coupled to an upper face of said strap adjacent to a first end of said strap;
a second fastener coupled to a lower face of said strap adjacent to a second end of said strap, said second fastener being complementary to said first fastener, wherein said second fastener is positioned on said strap such that said second fastener is positioned to couple to said first fastener to couple said strap to the suitcase, said first fastener and said second fastener comprising a hook and loop fastener;
a first housing coupled to said strap, said first housing defining an internal space, said first housing being positioned substantially equally distant from said first end and said second end of said strap;
a first power module coupled to said first housing and positioned in said internal space, said first power module comprising at least one first battery;
a plurality of lights coupled to said strap, each of said lights being positioned on said strap, said lights comprising light emitting diodes, said plurality of lights comprising a pair of strips, each said strip being coupled to said strap proximate to a respective opposing edge of said strap, each said strip extending between said first fastener and said second fastener;
a controller coupled to said first housing, said controller being operationally coupled to said first power module and said plurality of lights, wherein said controller is positioned on said first housing such that said controller is positioned for selectively operationally coupling said lights to said first power module, such that said lights are selectively illuminated to identify the suitcase, said controller comprising a switch, said switch being slidable, wherein said switch is positioned for sliding for selectively operationally coupling said lights to said first power module, said controller comprising a receiver, said receiver being configured for receiving wireless signal;
a remote operationally coupled to said controller, wherein said remote is positioned for wirelessly signaling said controller to selectively couple said first power module to said lights, such that said lights are selectively illuminated to identify the suitcase, said remote comprising:
a second housing defining an interior space,
a second power module coupled to said second housing and positioned in said interior space, said second power module comprising at least one second battery,
a transmitter coupled to said second housing and positioned in said interior space, said transmitter being operationally coupled to said second power module, said transmitter being configured for sending wireless signal, and
a control module coupled to said second housing, said control module being operationally coupled to said transmitter, wherein said control module is positioned on said second housing such that said control module is positioned for compelling said transmitter to transmit the wireless signal, such that said receiver is positioned for receiving the wireless signal, wherein said controller is positioned for selectively compelling coupling of said first power module to said lights, such that said lights are selectively illuminated to identify the suitcase, said control module comprising a button, said button being depressible, wherein said button is positioned on said second housing such that said button is configured for depressing for compelling said transmitter to transmit the wireless signal; and
wherein said second fastener is positioned on said strap such that said second fastener is positioned to couple to said first fastener to couple said strap to the suitcase, wherein said switch is positioned for sliding for selectively operationally coupling said lights to said first power module, such that said lights are selectively illuminated to identify the suitcase, wherein said button is positioned on said second housing such that said button is configured for depressing for compelling said transmitter to transmit the wireless signal, such that said receiver is positioned for receiving the wireless signal, wherein said controller is positioned for selectively compelling coupling of said first power module to said lights, such that said lights are selectively illuminated to identify the suitcase.
